(19) United States
(12) Patent Application Publication
(10) Pub. No.: US 2026/0038300 A1
(43) Pub. Date: Feb. 5, 2026

(54) BIOMETRIC IDENTIFICATION SYSTEM USING NON-PLANAR PLATEN

(71) Applicant: HID Global Corp., Austin, TX (US)

(72) Inventor: Daniel Henri Raguin, Jupiter, FL (US)

(21) Appl. No.: 18/788,811

(22) Filed: Jul. 30, 2024

(51) Int. Cl. G06V 40/13

(52) U.S. Cl. CPC G06V 40/1324

(57) ABSTRACT

In a biometric identification system, a transparent body can have a curved platen surface. The curved platen surface can be removably contacted by an anatomy of a user. The anatomy can have an anatomical pattern. An illumination source can illuminate the curved platen surface with an illumination beam. The illumination beam can propagate away from the curved platen surface as a return beam having a beam pattern shaped to correspond to the anatomical pattern. An imaging lens can focus the return beam to form a real image of the beam pattern at an image location. Field-curvature-correcting sensor optics can include a sensor. The sensor can sense the real image of the beam pattern at the image location. The field-curvature sensor optics can include a planar sensor and an image-flattener lens. The field-curvature sensor optics can include a curved, convex sensor.

### FIELD OF THE DISCLOSURE

The present disclosure relates generally to imaging systems for acquiring an image of a scannable portion of an anatomy, such as a fingerprint or a palmprint, such as for identification, enrollment, and/or verification.

### BACKGROUND OF THE DISCLOSURE

Biometric identification systems, such as fingerprint and palmprint identification systems, can identify, enroll, and/or verify an individual, such as for gaining access to a virtual or physical secured area, gaining access to a bank account, gaining access to a room or building through the unlocking of a door, and the like. There is ongoing effort to improve biometric identification systems.

### SUMMARY

In an example, a biometric identification system can include a transparent body having a curved platen surface. The curved platen surface can be removably contacted by an anatomy of a user. The anatomy can have an anatomical pattern. An illumination source can illuminate the curved platen surface with an illumination beam. The illumination beam can propagate away from the curved platen surface as a return beam having a beam pattern shaped to correspond to the anatomical pattern. An imaging lens can focus the return beam to form a real image of the beam pattern at an image location. Field-curvature-correcting sensor optics can include a sensor that can sense the real image of the beam pattern at the image location.

In an example, a method for operating a biometric identification system can include receiving, with a curved platen surface of a transparent body, removable contact from an anatomy of a user. The anatomy can have an anatomical pattern. The method can further include illuminating the curved platen surface with an illumination beam. The method can further include propagating the illumination beam away from the curved platen surface as a return beam having a beam pattern shaped to correspond to the anatomical pattern. The method can further include focusing, with an imaging lens, the return beam to form a real image of the beam pattern at an image location. The method can further include sensing, with a sensor of field-curvature-correcting sensor optics, the real image of the beam pattern at the image location.

In an example, a biometric identification system can comprise a transparent body having a curved platen surface. The curved platen surface can be removably contacted by an anatomy of a user. The anatomy can have an anatomical pattern. An illumination source can illuminate the curved platen surface with an illumination beam. The illumination beam can propagate away from the curved platen surface as a return beam having a beam pattern shaped to correspond to the anatomical pattern. A field lens can at least partially focus the return beam to form a converging beam. An objective lens can focus the converging beam to form a real image of the beam pattern at an image location. Field-curvature-correcting sensor optics can include a sensor. The sensor can sense the real image of the beam pattern at the image location. At least one processor can cause the sensor to capture at least one image of the beam pattern. The at least one processor can identify the user based at least in part on the at least one image of the beam pattern.

### BRIEF DESCRIPTION OF THE DRAWINGS

FIG. 1 shows a block diagram of an example of a biometric identification system.

FIG. 2A shows a side-view schematic drawing of an example of a curved platen system having cylindrical curvature and including a field lens.

FIG. 2B shows a top-view schematic drawing of the curved platen system of FIG. 2A.

FIG. 3A shows a side-view schematic drawing of an example of a curved platen system having cylindrical curvature and including an integrated field lens.

FIG. 3B shows a top-view schematic drawing of the curved platen system of FIG. 3A.

FIG. 4A shows a side-view schematic drawing of an example of a curved platen system having spherical curvature and including a field lens separate from the transparent body.

FIG. 4B shows a top-view schematic drawing of the curved platen system of FIG. 4A.

FIG. 5 shows a schematic drawing of an example of field-curvature-correcting sensor optics suitable for use in the biometric identification system of FIG. 1.

FIG. 6 shows a schematic drawing of an example of field-curvature-correcting sensor optics suitable for use in the biometric identification system of FIG. 1.

FIG. 7 shows a schematic drawing of an example of field-curvature-correcting sensor optics suitable for use in the biometric identification system of FIG. 1.

FIG. 8 shows a schematic drawing of an example of field-curvature-correcting sensor optics suitable for use in the biometric identification system of FIG. 1.

FIG. 9 shows a schematic drawing of an example of a portion of a biometric identification system.

FIG. 10 shows a top-view schematic drawing of an example of a portion of a biometric identification system.

FIG. 11 shows a side-view schematic drawing of an example of a portion of a biometric identification system.

FIG. 12 shows a side-view schematic drawing of an example of a portion of a biometric identification system.

FIG. 13 shows a flow chart for an example of a method for operating a biometric identification system.

Corresponding reference characters indicate corresponding parts throughout the several views. Elements in the drawings are not necessarily drawn to scale. The configurations shown in the drawings are merely examples and should not be construed as limiting in any manner.

### DETAILED DESCRIPTION

In a biometric identification system, a transparent body can have a curved platen surface. The curved platen surface can be removably contacted by an anatomy of a user. The anatomy can have an anatomical pattern. An illumination source can illuminate the curved platen surface with an illumination beam. The illumination beam can propagate away from the curved platen surface as a return beam having a beam pattern shaped to correspond to the anatomical pattern. An imaging lens can focus the return beam to form a real image of the beam pattern at an image location. Field-curvature-correcting sensor optics can include a sensor. The sensor can sense the real image of the beam pattern at the image location. The field-curvature sensor optics can include a planar sensor and an image-flattener lens. The field-curvature sensor optics can include a curved, convex sensor. Details regarding the biometric identification system follow below.

For the purposes of this document, the term cylindrical is intended to designate curvature along one axis, and planarity along an orthogonal axis. The cylindrical curvature can optionally include a zero or non-zero conic constant, and, optionally, one or more aspheric terms. Similarly, the terms asymmetric or anamorphic can designate a first curvature along a first axis, and a second curvature, different from the first curvature, along a second axis orthogonal to the first axis, where either or both of the first or second curvatures can optionally include a zero or non-zero conic constant, and, optionally, one or more aspheric terms. The term curved or curvature may additionally include more complex shapes than can easily be described by a conic constant and spheric terms, such as combination of a cylindrical portion (such as to accommodate a palm of a user) and an adjacent flat portion (such as to accommodate one or more fingers of the user). The term curved may include symmetric (e.g., rotationally symmetric about an optical axis or a central axis) curvatures or asymmetric curvatures (e.g. rotationally asymmetric curvatures, such as having a first curvature along a first axis that is orthogonal to the optical axis or central axis and a second curvature along a second axis that is orthogonal to the first axis and orthogonal to the optical axis or central axis).

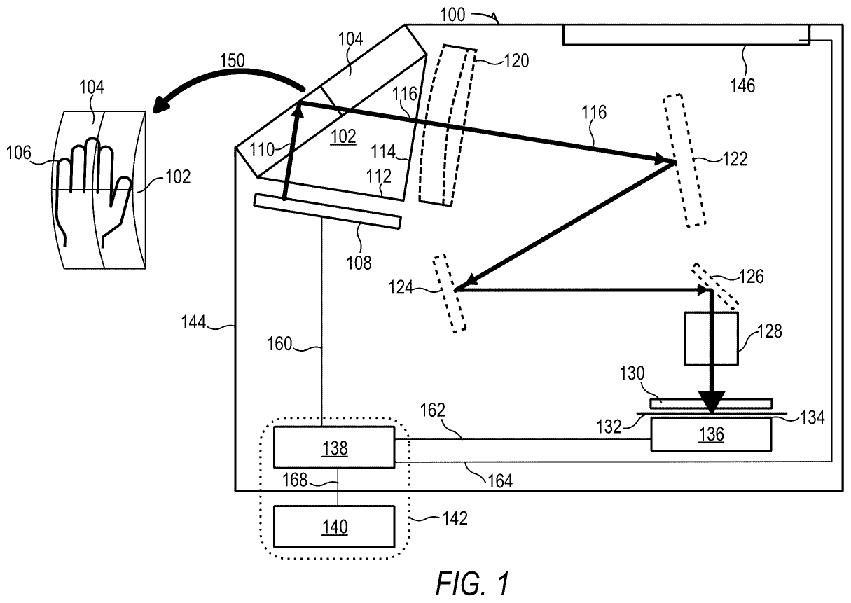

FIG. 1 shows a block diagram of an example of a biometric identification system 100. The configuration of FIG. 1 is but one example. Other configurations can also be used.

A transparent body 102, such as a prism or a plate, can have a curved platen surface 104. The curvature can be rotationally symmetric or rotationally asymmetric. The curved platen surface 104 can be removably contacted by an anatomy 106 of a user. For example, a user can place a hand on the curved platen surface 104. Other suitable anatomy can also be used. The anatomy 106 can have an anatomical pattern. For example, the anatomical pattern can include a handprint, a palmprint and/or a fingerprint. Other suitable anatomical patterns can also be used, which can correspond to the anatomy 106.

An arrow 150 shows an alternate perspective view of the curved platen surface 104 with an anatomy 106 of a user.

The biometric identification system 100 can include an illumination source 108. In some examples, the illumination source 108 can include a light-producing element, such as a laser or a light-emitting diode (LED). The light-producing element can produce light at a single wavelength or range of wavelengths, such as at or centered about 470 nm, 525 nm, 650 nm, or another suitable wavelength in the visible or infrared portion of the electromagnetic spectrum. In some examples, the light-producing element can produce light at multiple wavelengths. In some examples, the illumination source 108 can include a focusing element, such as an illumination lens. In some examples, the focusing element can at least partially focus light from the light-producing element to form an illumination beam 110. In some examples, the illumination beam 110 can be diffuse, such as with a specified angular scattering profile. In other examples, the illumination beam 110 can be collimated, converging, or diverging.

The illumination source 108 can illuminate the curved platen surface 104 with the illumination beam 110. For example, the anatomy 106 of the user can contact an air-incident side of the curved platen surface 104, and the illumination beam 110 can strike the curved platen surface 104 from an opposing side of the curved platen surface 104, such as from within the transparent body 102. In some examples, the transparent body 102 can be shaped as a prism having a substantially triangular cross-section, with the illumination source 108 directing illumination beam 110 into the transparent body 102 through a first surface 112 of the prism, the curved platen surface 104 forming a second surface of the prism that reflects the illumination beam 110, and the illumination beam 110 exiting the prism through a third surface 114 of the prism. Other suitable geometries can also be used.

The illumination beam 110 can propagate away from the curved platen surface 104 in a beam pattern that is shaped to correspond to the anatomical pattern. For example, the illumination beam 110 can strike the curved platen surface 104 at an incident angle (or a range of incident angles) that are greater than the critical angle. In regions for which the anatomy 106 does not contact the curved platen surface 104, such as recessed portions (e.g., skin valleys) between adjacent ridges of a fingerprint and palmprint, the illumination beam 110 can undergo total internal reflection (TIR) at the curved platen surface 104. In regions for which the user's skin (e.g., skin ridges) contacts the curved platen surface 104, the condition of total internal reflection is violated, and the amount of light reflected from these regions can be less, or significantly less, than the 100% or nearly 100% reflectance of total internal reflection. The regions of reduced reflectance can correspond to a handprint, fingerprint, or palmprint of the user.

The previously described illumination and imaging technique described above may be referred to as bright-field imaging. In bright-field imaging, a specular reflection of an illumination beam is directed towards the imaging subsystem, which produces an image that has bright pixels corresponding to areas of the skin anatomy that are valleys and dark pixels corresponding to ridges. An alternative approach to bright-field imaging may be referred to as dark-field imaging. In dark-field imaging, illumination is directed at the platen surface in such a manner that the specular reflection is not imaged by the imaging subsystem. Instead, the imaging subsystem images only scattered light. If the imaging subsystem is located to image light from the platen surface at an angle greater than the critical (TIR) angle of the transparent body for some material on the platen (e.g., air or water), then only areas of the skin anatomy that are touching the platen (e.g., ridges) and hence the TIR condition is not satisfied, will be capable of scattering light towards the imaging subsystem at a TIR angle. The valleys or areas where the anatomy is not present may appear dark. The result for the case of TIR imaging with dark-field illumination is therefore the image reversal of the previously described bright field imaging. In dark-field illumination, ridges may correspond to bright image pixels and valleys may correspond to dark image pixels. A third illumination and imaging technique may use dark-field illumination, but the imaging subsystem captures non-TIR light scattered from the platen and skin anatomy. In this third technique, the contrast of the skin topology ridges and valleys may not be as large as for bright-field imaging or dark-field imaging, so that additional image processing may enhance the contrast as needed. In any or off of the illumination and imaging techniques, a curved platen surface and correcting image and sensor optics can be utilized to enhance the resulting image resolution.

The biometric identification system 100 can include an optional field lens 120 that is optionally configured such that an image of the anatomy 106 is telecentric in object space. The condition of telecentricity can remove or decrease trapezoidal distortion that may otherwise be present in the image. The return beam 116 can exit the transparent body 102 at the third surface 114 and enter the optional field lens 120. The optional field lens 120 can be configured to at least partially focus the return beam 116 to form a converging beam.

In some examples, the return beam 116 can optionally reflect from one or more mirrors 122, 124, 126. In some examples, the one or more mirrors 122, 124, 126 can direct the return beam 116 to an objective lens 128. In some examples, the one or more mirrors 122, 124, 126 can be positioned to make a compact light path between field lens 120 and objective lens 128. In some examples, the one or more mirrors 122, 124, 126 can be selected to ensure a suitable form factor for the biometric identification system 100 to fit within a housing 144.

An objective lens 128 can form an image of the beam pattern in an image location 132. In some examples, the objective lens 128 can be formed from a single transparent lens element. In some examples, the objective lens 128 can be formed from two or more transparent lens elements. In some examples, one or more of the transparent lens elements can be rotationally symmetric about an optical axis (or central axis) of the objective lens 128. In some examples, one or more of the transparent lens elements can be rotationally asymmetric about the optical axis (or central axis).

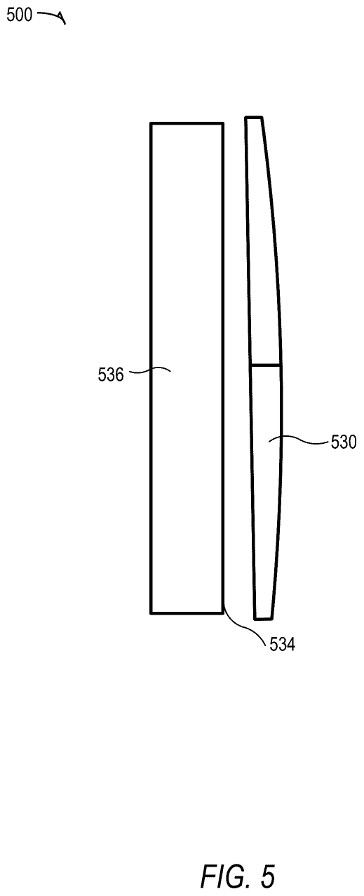

Corrective optics 130 can flatten the image at the image location 132 prior to sensing the image, as discussed below with reference to FIGS. 5-8.

A sensor 136 can sense the image of the beam pattern. For example, the sensor 136 can be a multi-pixel sensor, such as a complementary metal-oxide-semiconductor (CMOS) sensor, in which each pixel can generate a measurable voltage, current, or accumulated charge in response to incident light. The sensor 136 can be disposed orthogonally or non-orthogonally with respect to the optical axis of the objective lens 128. The sensor 136 can have a sensor surface 134. In practice, during use of the biometric identification system 100, the image location 132 can coincide with the sensor surface 134. In FIG. 1, the image location 132 and the sensor surface 134 are shown as being separated only for clarity.

The biometric identification system 100 can include at least one processor 142. The at least one processor 142 can include a local processor 138. In some examples, the at least one processor 142 can include a remote processor 140, such as a server or host computer, that can be external to a housing 144 of the biometric identification system 100. The local processor 138 can communicate via a wired or wireless connection 168 with the remote processor 140. The local processor 138 can provide electrical power to any of the illumination source 108, the sensor 136, and the display 146 (described below). In some examples, the local processor 138 can perform tasks that are internal to the housing 144, such as instructing the sensor 136 to wake up from sleep mode, instructing the sensor 136 to change a binning mode or frame rate, and so forth. The local processor 138 can also receive data from the sensor 136, such as image data. In some examples, communication between the local processor 138 and the sensor 136 can be bidirectional. In some examples, the remote processor 140 can perform functions that involve access to a database or involve significant computation. In some examples, any or all of the functions performed by the at least one processor 142 can be performed by the local processor 138, the remote processor 140, or a combination of the local processor 138 and the remote processor 140.

The at least one processor 142 can further verify, enroll, and/or identify the user based at least in part on the captured image of the beam pattern. In some examples, the local processor 138 can perform the verifying, enrolling, and/or identifying. In some examples, the remote processor 140 can perform the verifying, enrolling, and/or identifying. In some examples, the local processor 138 and the remote processor 140, together, can perform the verifying, enrolling, and/or identifying.

For example, the at least one processor 142 can compare a handprint of a user to a database of handprints, determine that the user has access to a room, and unlock a door to the room. This is but one example of verifying and/or identifying the user based at least in part on the captured image of the beam pattern; other suitable applications are possible. In a comparable example, the handprint of the user may not yet be present in the database, so that the user can be enrolled based at least in part on the captured image of the beam pattern.

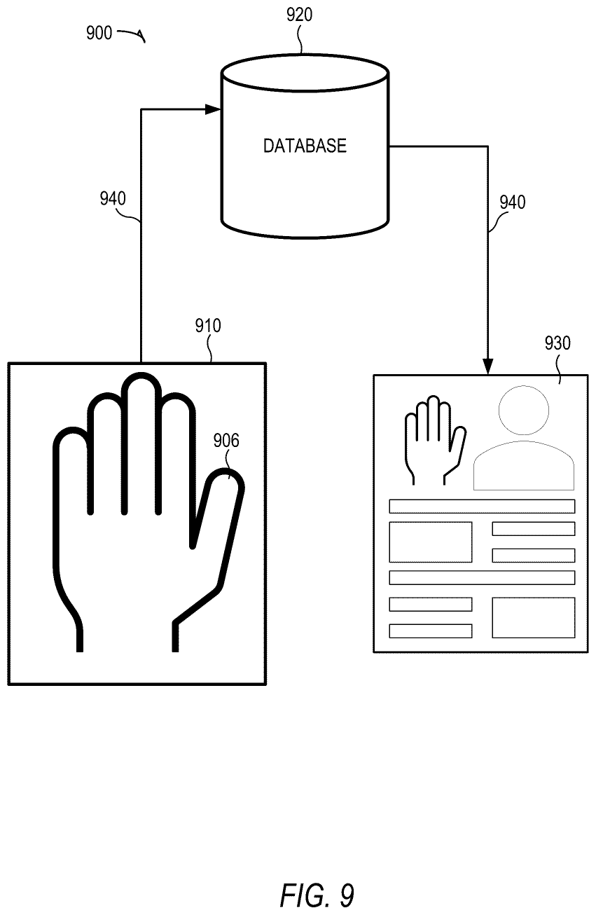

The biometric identification system 100 can include a display 146. The display 146 can be any suitable size and use any suitable display technology (e.g., LCD, LED, etc.). The display 146 can be configured to display any suitable text, images, and video. For example, the display 146 can be configured to show a status message of the biometric identification system 100, such as “Ready”, “Scan In Progress”, etc. Further, the display 146 can be configured to display a result of comparing the handprint of the user to the database of handprints, as discussed below with regard to FIG. 9. Pictograms may be included in display 146 to illustrate which hand or which fingers the biometric identification system 100 expects to be scanned and the status of the skin topology captured for a given part of an anatomy.

The biometric identification system 100 can use a curved platen surface 104 for removable contact by the anatomy 106 of the user. Using the curved platen surface 104 for removable contact by the anatomy of the user can provide several benefits, compared to a biometric identification system in which the platen surface does not contain any curvature (e.g., is flat or planar).

A first benefit can be allowing the anatomy 106 of the user to include the entire hand of the user. For example, the biometric identification system 100 can capture an image of a large area starting at the fingertips, including the palm area with curvature, and extending to the wrist of the user. Further, the biometric identification system 100 can include thumb anatomy in the captured image. Further, the biometric identification system 100 can be configured to capture an image of both the left hand anatomy and the right hand anatomy of the user. The biometric identification system 100 can additionally accommodate the optional use of a silicone membrane disposed on the curved platen surface 104 (e.g., disposed between the curved platen surface 104 and the hand, specifically palm, of the user). U.S. Pat. No. 7,319,565, which is incorporated herein by reference, discusses use of a silicone membrane in a palmprint scanner. In the biometric identification system 100, the silicon membrane can be planar and can be bendable. For example, the silicon membrane can be positioned on the curved platen surface 104 without causing a gap to form between the planar membrane and the curved platen surface 104. Although the curvatures described herein include curvatures that allow a planar silicone membrane to envelope the curved platen without wrinkles, which include objects that have uniform cross-section with respect to a given axis and cones, other suitable curvatures can also be used.

A second benefit can be ease-of-use by the user. The biometric identification system 100 having a curved platen surface 104 can be used in environments where there is a need to quickly capture larger areas of skin topology (e.g., larger than a fingerprint) from a user. For example, speed of identification is important in a border security environment, where a system can rapidly and sequentially perform identification on a queue of individuals. Further, a planar platen surface that scans the lower palm may require significant pressure to be placed on the user's hand to capture the required image. For example, the identification system having a planar platen surface may require users to be assisted and can require several attempts before an adequate identification can be made with the acquired imagery.

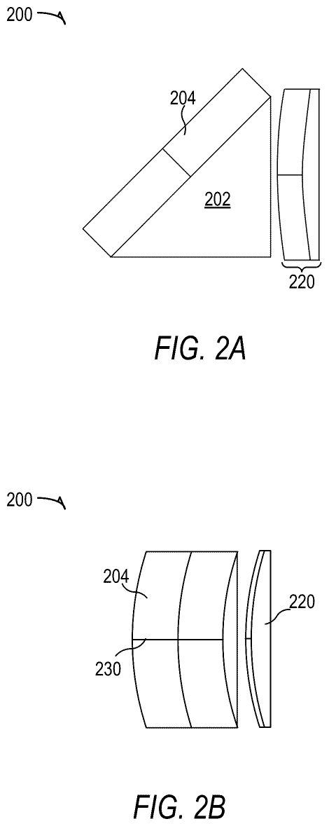

FIG. 2A shows a side-view schematic drawing of an example of a curved platen system 200 having cylindrical curvature and including a field lens 220. FIG. 2B shows a top-view schematic drawing of the curved platen system of FIG. 2A. The curved platen system 200 is suitable for use in the biometric identification system 100 of FIG. 1. The configurations of FIGS. 2A and 2B are but mere examples of a curved platen system 200 that is suitable for use in the biometric identification system of FIG. 1; other configurations can also be used.

The transparent body 202, curved platen surface 204, and field lens 220 can be similar in structure and function to the transparent body 102, curved platen surface 104, and field lens 120, respectively.

The transparent body 202, such as a prism or a plate, can have a curved platen surface 204. The curved platen surface 204 can be removably contacted by an anatomy 106 of a user, as shown in FIG. 1 where the curved platen surface 104 is shown in a top-down view. The curved platen surface 204 can accommodate a natural curvature of the anatomy 106 including the fingers and palm of the user. In particular, the area of anatomy 106 corresponding to the lower palm can be cupped. The curved platen surface 204 can be shaped to accommodate this natural cupping so that the biometric identification system 100 can image the entire hand, including the lower palm skin topology, all at once, with minimal or relatively little hand pressure.

The curved platen surface 204 can have curvature in one dimension. The curved platen surface 204 can have a convex shape as viewed by the user. The curved platen surface 204 can have a single radius of curvature. The curved platen surface 204 can have more than one radius of curvature. For example, the curved platen surface 204 can be described by an aspheric formula, such as including one or more non-zero aspheric coefficients and/or a non-zero conic constant. As another example, the curved platen surface 204 can be toroidal.

In the configuration of FIGS. 2A and 2B, the field lens 220 can be spaced apart from the transparent body 202. The field lens 220 can further be configured to at least partially focus the return beam (such as return beam 116) to form a converging beam.

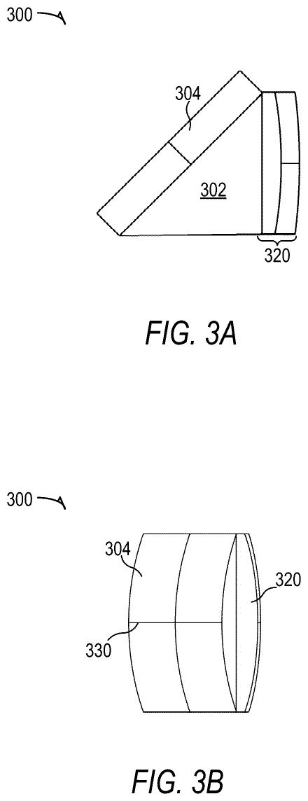

FIG. 3A shows a side-view schematic drawing of an example of a curved platen system 300 having cylindrical curvature and including an integrated field lens 320. FIG. 3B shows a top-view schematic drawing of the curved platen system 300 of FIG. 3A. The curved platen system 300 is suitable for use in the biometric identification system of FIG. 1. The configurations of FIGS. 3A and 3B are but mere examples of a curved platen system 300 that is suitable for use in the biometric identification system of FIG. 1; other configurations can also be used.

The transparent body 302 and curved platen surface 304 can be similar in structure and function to the transparent body 102 and platen surface 104, respectively.

In the configuration of FIGS. 3A and 3B, the field lens 320 can be integrated into the transparent body 302 of the curved platen system 300, such as by forming a curved side of the transparent body 302. The integrated field lens 320 can at least partially focus the return beam (such as return beam 116) to form a converging beam.

In the configurations of FIGS. 3A and 3B, the field lens 320 can be integral with the transparent body 302. For these configurations, the curved platen surface 304 can have any suitable shape, such as spherical, aspherical, rotationally symmetric, rotationally asymmetric, generally cylindrical (e.g., having a cross-section that is uniform over a length along the curved platen surface 304), explicitly cylindrical, irregular, or others.

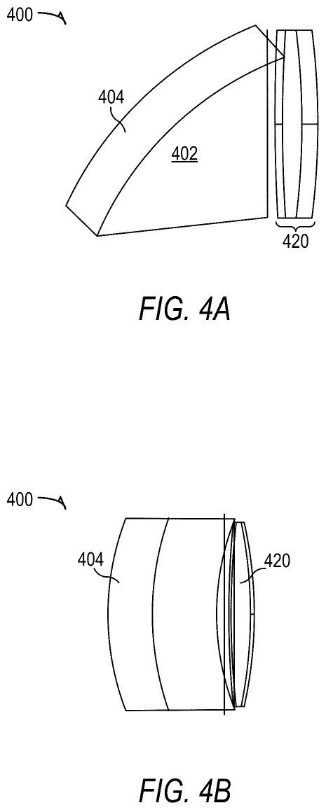

FIG. 4A shows a side-view schematic drawing of an example of a curved platen system 400 having spherical curvature and including a field lens 420 separate from the transparent body 402. FIG. 4B shows a top-view schematic drawing of the curved platen system 400 of FIG. 4A. The curved platen system 400 is suitable for use with the biometric identification system 100 of FIG. 1. The configurations of FIGS. 4A and 4B are but mere examples of a curved platen system 400 that is suitable for use in the biometric identification system of FIG. 1; other configurations can also be used.

The transparent body 402, curved platen surface 404, and field lens 420 can be similar in structure and function to the transparent body 102, curved platen surface 104, and field lens 120, respectively, or similar in structure and function to the transparent body 202, curved platen surface 204, and field lens 220, respectively, or similar in structure and function to the transparent body 302, curved platen surface 304, and field lens 320. For example, the transparent body 402 with the spherically curved platen surface 404 can be separate from the field lens 420 or can be integral with the field lens 420. Curved platen surface 404 can have curvature in two dimensions. Curved platen surface 404 can have a convex shape as viewed by the user. In another example, curved platen surface 404 can be toroidal. The field lens 420 can at least partially focus the return beam (such as return beam 116) to form a converging beam.

In the configurations of FIGS. 4A and 4B, the field lens 420 can be spaced apart from the transparent body 402. For these configurations, the curved platen surface 404 can have any suitable shape, such as spherical, aspherical, rotationally symmetric, rotationally asymmetric, generally cylindrical (e.g., having a cross-section that is uniform over a length along the curved platen surface 404), explicitly cylindrical, irregular, or others.

In the biometric identification system 100, the objective lens 128 can produce an image of the anatomy 106 present at the curved platen surface 104 at the image location 132. When any of curved platen surface 104, 204, 304, and 404 is used in the biometric identification system 100, the image produced at the image location 132 can include field curvature. A system of corrector optics can flatten the image at the image location 132 prior to sensing the image.

FIG. 5 shows a schematic drawing of an example of field-curvature-correcting sensor optics 500 suitable for use in the biometric identification system 100 of FIG. 1. The configuration of FIG. 5 is but one example of suitable field-curvature-correcting sensor optics; other configurations can also be used.

In the example of FIG. 5, an image-flattener lens 530 can perform the function of the corrective optics 130 of FIG. 1. The sensor 536 and sensor surface 534 can perform the function of the sensor 136 and the sensor surface 134 of FIG. 1, respectively.

The image-flattener lens 530 can be disposed between the objective lens 128 and the sensor 536. The image-flattener lens 530 and the sensor surface 534 can optionally be positioned at an angle relative to the optical axis of the objective lens 128. For example, the image-flattener lens 530 and the sensor surface 534 can be tilted at a Scheimpflug angle.

The image-flattener lens 530 can be plano-convex. The image-flattener lens 530 can be plano-concave. The image-flattener lens 530 can be convex-concave. The image-flattener lens 530 can be aspheric. Further, when used with a curved platen surface having cylindrical curvature such as curved platen surface 204 and curved platen surface 304, the image-flattener lens 530 can alternatively be a cylindrical meniscus lens, a convex-concave lens, an aspheric lens, or a plano-concave cylindrical lens.

The sensor 536 can be any suitable digital image sensor having a sensor surface 534 that is planar. For example, sensor 536 can be a CMOS sensor or a charged-coupled device (CCD) sensor.

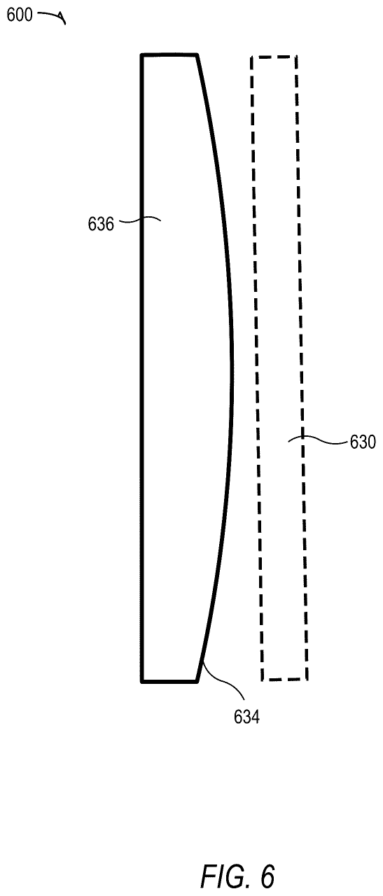

FIG. 6 shows a schematic drawing of an example of field-curvature-correcting sensor optics 600 suitable for use in the biometric identification system 100 of FIG. 1. The configuration of FIG. 6 is but one example of suitable field-curvature-correcting sensor optics; other configurations can also be used.

The sensor 636 and sensor surface 634 can perform the function of the sensor 136 and the sensor surface 134 of FIG. 1, respectively.

The plate 630 can optionally be disposed between the objective lens 128 and the sensor 636. The plate 630 can be a cover glass, a spectral filter such as a bandpass filter, low-pass filter or high-pass filter, or another suitable planar element. The plate 630 can optionally be omitted entirely such that there is an absence of intervening optical elements disposed between the sensor surface 634 and the objective lens 128.

The sensor 636 can be any suitable digital image sensor having a sensor surface 634 that is curved. For example, sensor 636 can be a CMOS sensor or a CCD sensor. Further, sensor surface 634 can have any suitable curvature. In an example, sensor surface 634 can be concave cylindrical. In another example, sensor surface 634 can have spherical curvature. As shown in FIG. 6, sensor surface 634 can be convex cylindrical with respect to the optical axis of the objective lens 128.

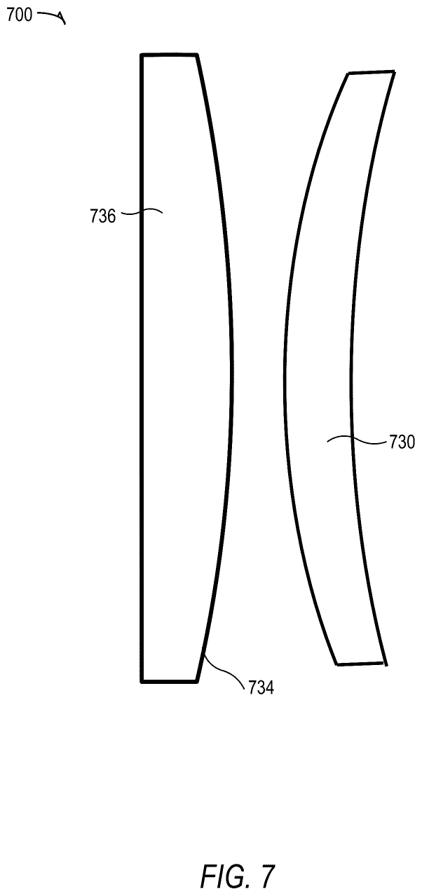

FIG. 7 shows a schematic drawing of an example of field-curvature-correcting sensor optics 700 suitable for use in the biometric identification system 100 of FIG. 1. The configuration of FIG. 7 is but one example of suitable field-curvature-correcting sensor optics; other configurations can also be used.

In the example of FIG. 7, the positive meniscus cylinder lens 730 can perform the function of corrective optics 130 of FIG. 1. The sensor 736 and sensor surface 734 can perform the function of the sensor 136 and the sensor surface 134 of FIG. 1, respectively.

The sensor 736 can be substantially similar to the sensor 636 as discussed above. The sensor 736 can have a sensor surface 734 that is curved substantially similar to the sensor surface 634 as discussed above.

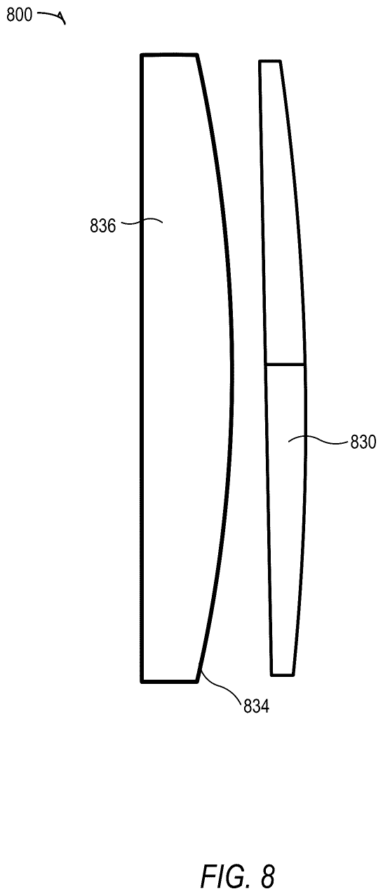

FIG. 8 shows a schematic drawing of an example of field-curvature-correcting sensor optics 800 suitable for use in the biometric identification system 100 of FIG. 1. The configuration of FIG. 8 is but one example of suitable field-curvature-correcting sensor optics; other configurations can also be used.

In the example of FIG. 8, the plano-convex lens 830 can perform the function of corrective optics 130 of FIG. 1. The sensor 836 and sensor surface 834 can perform the function of the sensor 136 and sensor surface 134 of FIG. 1, respectively.

The sensor 836 can be substantially similar to the sensor 636 as discussed above. The sensor 836 can have a sensor surface 834 that is curved substantially similar to the sensor surface 634 as discussed above.

FIG. 9 shows a schematic drawing of an example of a portion of a biometric identification system 900. The biometric identification system 900 of FIG. 9 is but one example of a system for verifying an anatomy of a user; other systems can also be used.

An image 910 captured by the biometric identification system 900 can include a user anatomy 906. The user anatomy 906 can include fingertips, thumb, and/or palm areas of a user's hand.

The biometric identification system 900 can perform any suitable analysis on the image 910. For example, a local processor, such as the local processor 138, can determine a contrast of at least one area of the user anatomy 906 in the image 910. The biometric identification system 900 can determine that the contrast of at least one area of the user anatomy 906 in the image 910 meets at least one threshold condition. For example, the biometric identification system 900 can determine that the contrast of the image does meet or exceed the threshold contrast value. The biometric identification system 900 can determine that the contrast of at least one other area of the user anatomy 906 in the image 910 may not meet at least one threshold condition. For example, the biometric identification system 900 can determine that the contrast of the image 910 does not exceed the threshold contrast value.

There are several suitable ways to measure a contrast of an image. For example, a contrast of an image can be defined as a quantity C=(X−Y)/(X+Y), where quantity X is a maximum intensity value in the image and quantity Y is a minimum intensity value in the image. For this definition, the contrast can have a value between 0 and 1, inclusive. As another example, the contrast can be defined as corresponding to an edge spread function along a direction or along orthogonal directions. As another example, the contrast can be defined as corresponding to a point spread function (PSF). As another example, the contrast can be defined as corresponding to a modulation transfer function (MTF) at one or more specified spatial frequencies. In some examples, the spread function(s) and/or transfer function(s) can be obtained from one or more marks that appear on the curved platen surface 104 outside a capture field of view of the anatomy 106 but within a field of view of the objective lens 128. In other examples, the contrast of the image may be measured by examining the power spectrum of the image. A defocused image can have lower magnitudes for high-spatial frequencies components (i.e., lower contrast at those spatial frequencies) compared to a well-focused imaged. Other suitable definitions for contrast can also be used.

When the biometric identification system 900 determines that the contrast of at least one area of the user anatomy 906 in the image 910 does not meet at least one threshold condition, the biometric identification system 900 can provide user feedback (e.g., by displaying a message on display 146). User feedback can include any suitable message, such as instructions to reposition a portion of the user anatomy 906.

When the biometric identification system 900 determines that the contrast of at least one area of the user anatomy 906 in image 910 meets at least one threshold condition, the biometric identification system 100 can use a wired or wireless communication link 940 (e.g., implemented using the local processor 138) to transmit data representing the image to a database 920 (e.g., implemented using the remote processor 140).

The biometric identification system 900 can alternatively transmit data representing portions of image 910 to the database 920. For example, the biometric identification system 900 can perform any suitable pre-determined image analysis or manipulation (e.g., cropping, shrinking, enhancing contrast, etc.). Further, the biometric identification system 900 can transmit a portion of the palmprint area of the image 910 or the fingerprint areas of the image 910. Further, the biometric identification system 900 can include any data output from image analysis (e.g., measurements of the user anatomy 906 such as size of palm, distance from palm to fingertip, etc.) when the biometric identification system 900 communicates with the database 920 over communication link 940.

The remote processor 140 can be configured to perform any suitable analysis on information received from the biometric identification system 900. For example, the remote processor 140 can receive the image 910 and can perform any of the image analysis or manipulation described above.

The database 920 can be any suitable database that includes user-identifiable information. For example, the database 920 can include records of user anatomy, such as handprints, palm prints, fingerprints, and so forth. Further, the database 920 can include additional identifying information of a user such as a name, address, nationality, photograph of facial features, and so forth.

The database 920 can be further configured to perform search functions on records contained in the database 920. The database 920 can return matches for the user anatomy 906 contained in the received information. The database 920 can sort, filter, and rank a series of matches on records in database 920 for the user anatomy 906. The database 920 can determine that a record in the series of matches meets a threshold for matching information in the record with received information (including the user anatomy 906).

The remote processor 140 and database 920 can be further configured to perform verification functions. For example, when the database 920 determines a matching record in the database 920, the remote processor 140 can further determine if the identity contained in the matching record is authorized to access environmental areas beyond the biometric identification system 900. As a specific example, the remote processor 140 can determine, using information contained in records in the database 920, that the image 910 corresponds to a particular individual who is returning to a country of origin from a business trip. In this specific example, the remote processor 140 can determine that the particular individual is authorized to move past a customs checkpoint where the biometric identification system 900 is installed.

The remote processor 140 and database 920 can use communication link 940 to communicate results of a search function to the biometric identification system 900. For example, using the example of FIG. 9, the database 920 can communicate identification record 930 to the biometric identification system 900. Further, once the biometric identification system 900 has received identification record 930 from the database 920, the verification function described above as performed by the remote processor 140 can alternatively be performed at the local processor 138.

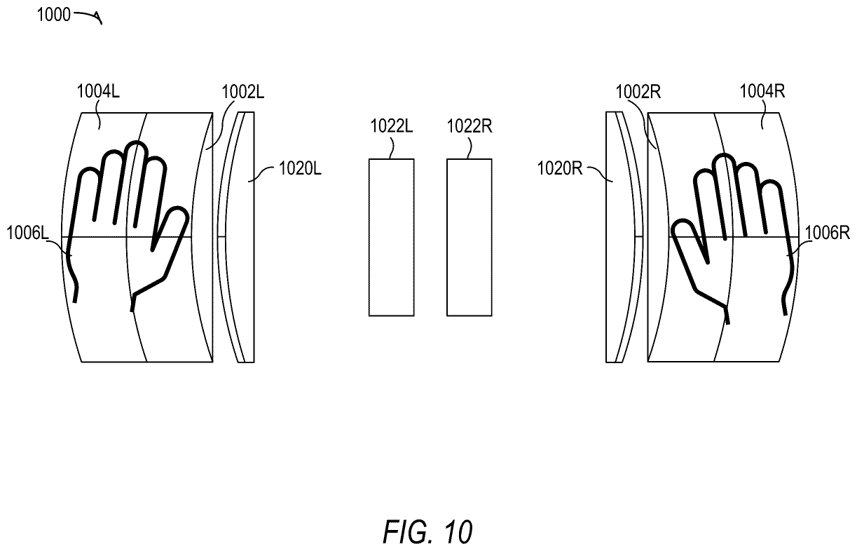

FIG. 10 shows a top-view schematic drawing of an example of a portion of a biometric identification system 1000. The biometric identification system 1000 can capture two images, one from each hand of the user. As such, the biometric identification system 1000 can include two sets of many of the optical components, one for each hand of the user. For case of reference, the components for the left hand 1006L are denoted with the suffix “L” and the components for the right hand 1006R are denoted with the suffix “R”.

The biometric identification system 1000 can include a first transparent body 1002L and a second transparent body 1002R. Each of the first transparent body 1002L and second transparent body 1002R can have a curved platen surface, shown as curved platen surfaces 1004L and 1004R, respectively. The curved platen surface 1004L for the left hand 1006L and the curved platen surface 1004R for the right hand 1006R can optionally be shaped to be mirror-images of each other. The curved platen surface 1004L can have the same curvature as the curved platen surface 1004R. The curved platen surface 1004L can be configured to be removably contacted by a first user anatomy, such as the left hand 1006L of the user. The curved platen surface 1004R can be configured to be removably contacted by a second user anatomy, such as the right hand 1006R of the user. For example, curved platen surface 1004L can have the same curvature as curved platen surface 1004R, and the curved platen surface 1004L can be oriented with an axis of the radius of curvature at an angle relative to the curved platen surface 1004R. Further, curved platen surface 1004L can be oriented in-plane at any suitable angle with respect to curved platen surface 1004R. The platen surface 1004L and curved platen surface 1004R can be configured so that a user can comfortably and simultaneously position both the left hand 1006L and the right hand 1006R on biometric identification system 1000.

The biometric identification system 1000 can include a first field lens 1020L and a second field lens 1020R, which can be similar in structure and function to the field lens 120 (FIG. 1).

The biometric identification system 1000 can include a mirror 1022L and a mirror 1022R. As discussed below, each of mirror 1022L and 1022R can be configured to direct reflected light to respective imaging systems.

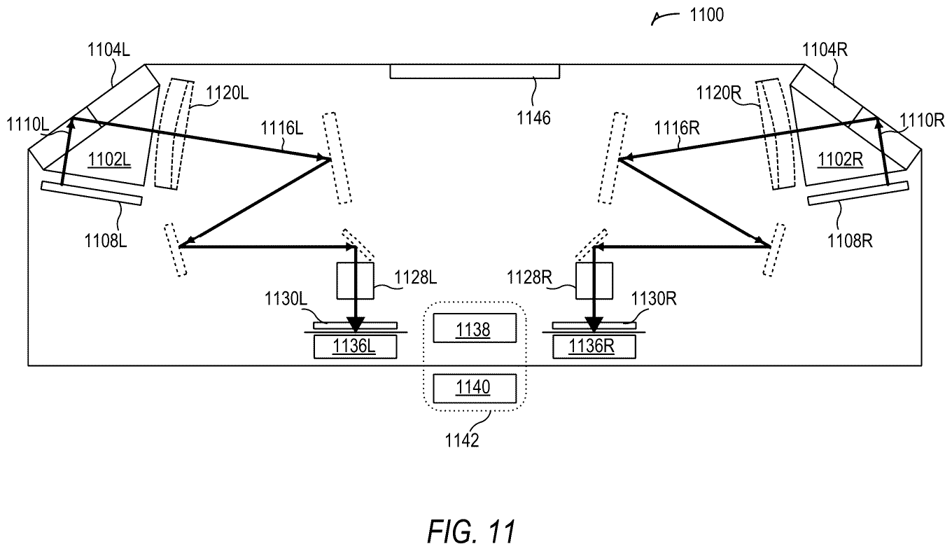

FIG. 11 shows a side-view schematic drawing of an example of a portion of a biometric identification system 1100. The biometric identification system 1100 can include all of the components of biometric identification system 100 and can additionally include a second set components. As shown, FIG. 11 includes a first transparent body 1102L having a curved platen surface 1104L and second transparent body 1102R having a curved platen surface 1104R. As discussed above with reference to FIG. 10, the biometric identification system 1100 can include a first transparent body 1102L and a second transparent body 1102R in order to image a left hand and a right hand, respectively.

A first illumination source 1108L and a second illumination source 1108R can each be similar in structure and function to the illumination source 108 (FIG. 1). A first illumination beam 1110L can propagate away from the first curved platen surface 1104L as beam 1116L in a first beam pattern shaped to correspond to the anatomical pattern of the left hand. A second illumination beam 1110R can propagate away from the second curved platen surface 1104R as beam 1116R in a second beam pattern shaped to correspond to the anatomical pattern of the right hand.

The biometric identification system 1100 can include a first field lens 1120L and a second field lens 1120R. The first field lens 1120L and the second field lens 1120R can be similar in structure and function to the field lens 120 (FIG. 1). The first field lens 1120L can be configured to at least partially focus the first return beam to form a converging beam 1116L. The second field lens 1120R can be configured to at least partially focus the second return beam to form a second converging beam 1116R.

The first field lens 1120L can be separated from the first transparent body 1102L or can be integrated with the first transparent body 1102L. The second field lens 1120R can be separated from the second transparent body 1102R or can be integrated with the second transparent body 1102R.

The biometric identification system 1100 can include a first objective lens 1128L and a second objective lens 1128R. Each of first objective lens 1128L and second objective lens 1128R can be similar in structure and function to the objective lens 128 (FIG. 1). For example, the first objective lens 1128L can have identical components to the second objective lens 1128R in order to ensure a similar image capture of both of the left hand and the right hand of the user.

The biometric identification system 1100 can include first corrective optics 1130L and second corrective optics 1130R. First corrective optics 1130L and second corrective optics 1130R can include any suitable corrective optics, such as sensor optics 500, 600, 700, or 800 as described above. The first corrective optics 1130L and the second corrective optics 1130R can use similar components to ensure a similar image capture for both of the left hand and the right hand of the user. Alternatively, the first corrective optics 1130L and the second corrective optics 1130R may use different components, such as when each respective optical path has differing aberrations or degradation in image quality.

The biometric identification system 1100 can include a first sensor 1136L and a second sensor 1136R, which can be similar in structure and function to the sensor 136 (FIG. 1).

The biometric identification system 1100 can include at least one processor 1142. The at least one processor 1142 can include a local processor 1138. The at least one processor 1142 can include a remote processor 1140, such as a server or host computer, that can be external to a housing 1144 of the biometric identification system 1100. The local processor 1138 can communicate via a wired or wireless connection with the remote processor 1140. The local processor 1138 can provide electrical power to any or all of the first illumination source 1108L, the second illumination source 1108R, the first sensor 1136L, the second sensor 1136R, or the display 1146. In some examples, the local processor 1138 can perform tasks that are internal to the housing 1144, such as instructing the first sensor 1136L to wake up from sleep mode, instructing at least one of the first sensor 1136L or the second sensor 1136R to change a binning mode or frame rate, and so forth. The local processor 1138 can also receive data, such as image data, from at least one of the first sensor 1136L or the second sensor 1136R. In some examples, communication between the local processor 1138 and the first sensor 1136L or the second sensor 1136R can be bidirectional. In some examples, the remote processor 1140 can perform functions that involve access to a database or involve significant computation. In some examples, any or all of the functions performed by the at least one processor 1142 can be performed by the local processor 1138, the remote processor 1140, or a combination of the local processor 1138 and the remote processor 1140.

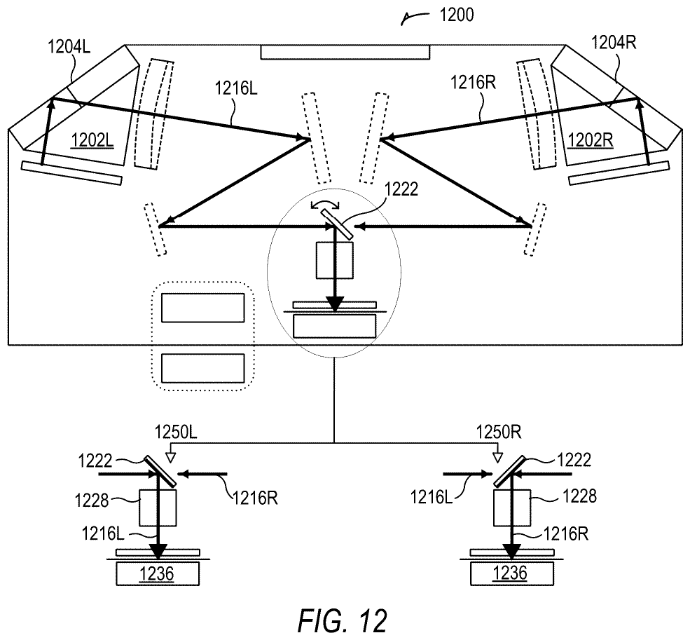

FIG. 12 shows a side-view schematic drawing of an example of a portion of a biometric identification system 1200. The biometric identification system 1200 can include a first transparent body 1202L having a curved platen surface 1204L, a second transparent body 1202R having a curved platen surface 1204R, and various optical components similar in structure and function to those in FIG. 11, which can direct a first return beam 1216L and a second return beam 1216R toward a movable mirror 1222.

The movable mirror 1222 can switch between a first position 1250L as seen in the left-side inset and a second position 1250R as seen in the right-side inset. When the movable mirror 1222 is in the first position 1250L, the movable mirror 122 can direct the first return beam 1216L toward the objective lens 1228, and the objective lens 1228 can form an image of the curved platen surface 1204L on the sensor 1236. When the movable mirror 1222 is in the second position 1250R, the movable mirror 122 can direct the second return beam 1216R toward the objective lens 1228, and the objective lens 1228 can form an image of the curved platen surface 1204R on the sensor 1236. However, in configurations where the platens 1204L and 1204R are tilted, such as in the case of the TIR imaging shown in FIG. 12, then the sensor may be tilted. In the geometry shown in FIG. 12, the tilt direction for the optical system shown on the left of FIG. 12 may be opposite from that on the right of FIG. 12. To adjust for this difference, then, in addition to flipping mirror 1222, then sensor 1236 may also be flipped. Alternatively (or additionally), one or both sides of the optical system of FIG. 12 may have one or more optical elements added to eliminate or minimize the sensor tilt difference between the two sides of the optical system. For example, a Dove prism may be inserted into the system to make the sensor tilt for both sides of optical system illustrated in FIG. 12 the same. In some examples, the Dove prism (or other optical element) may be inserted between a platen 1204 and the mirror 1222. In other examples, the prism may be inserted between the mirror 1222 and the sensor, which may allow for the use of a smaller Dove prism. The resulting image from the Dove prism may be flipped on one axis, such that an additional optical element can flip the image back optically. Alternatively, the flipping may be performed digitally.

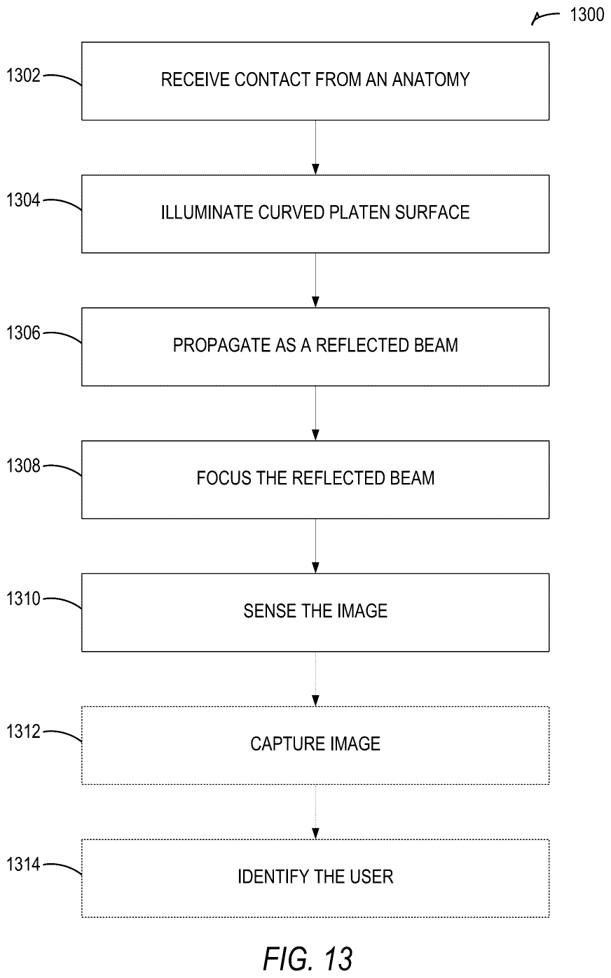

FIG. 13 shows a flow chart of an example of a method 1300 for operating a biometric identification system. The method 1300 can be executed by any or all of the systems 100, 900, 1000, 1100, 1200, or by any other suitable biometric identification system. The method 1300 of FIG. 13 is but one example of a method for operating a biometric identification system. Other suitable methods can also be used.

At operation 1302, the biometric identification system can receive contact by an anatomy of a user on a curved platen surface of a transparent body. The anatomy can have an anatomical pattern.

At operation 1304, the biometric identification system can illuminate the curved platen surface with an illumination beam.

At operation 1306, the illumination beam can propagate away from the curved platen surface in a return beam. The return beam can have a beam pattern that is shaped to correspond to the anatomical pattern.

At operation 1308, the biometric identification system can focus, with an imaging lens having an optical axis, the return beam to form a real image of the beam pattern at an image location.

At operation 1310, the biometric identification system can sense (e.g., detect), with a sensor, the real image of the beam pattern at the image location. The sensor can have field-curvature-correcting optics.

The method 1300 can optionally further include, at operation 1312, causing the sensor to capture at least one image of the beam pattern at the image location.

The method 1300 can optionally further include, at operation 1314, at least one of verifying, enrolling, or identifying the user based at least in part on the captured image of the beam pattern.

In some examples, the platen surface and the image plane can each be angled non-orthogonally with respect to the optical axis. In some examples, the sensor can be disposed non-orthogonally with respect to the optical axis. In some examples, the sensor can be planar and can have field-curvature-correcting sensor optics. In some examples, the sensor can be curved and can optionally have field-curvature-correcting sensor optics.

In some examples, the anatomy of the user can be a finger of the user. In some examples, the anatomical pattern can be a fingerprint pattern. In some examples, the anatomy of the user can be at least one hand of the user. In some examples, the anatomical pattern can be at least one palmprint.

To further illustrate the systems and related methods disclosed herein, a non-limiting list of examples is provided below. Each of the following non-limiting examples may stand on its own or may be combined in any permutation or combination with any one or more of the other examples.

In Example 1, a biometric identification system can comprise: a transparent body having a curved platen surface, the curved platen surface configured to be removably contacted by an anatomy of a user, the anatomy having an anatomical pattern; an illumination source configured to illuminate the curved platen surface with an illumination beam, the illumination beam configured to propagate away from the curved platen surface as a return beam having a beam pattern shaped to correspond to the anatomical pattern; an imaging lens configured to focus the return beam to form a real image of the beam pattern at an image location; and field-curvature-correcting sensor optics including a sensor, the sensor being configured to sense the real image of the beam pattern at the image location.

In Example 2, the biometric identification system of Example 1 can optionally be configured such that: the sensor is planar; and the field-curvature-correcting sensor optics further include an image-flattener lens disposed between the imaging lens and the sensor.

In Example 3, the biometric identification system of any one of Examples 1-2 can optionally be configured such that the image-flattener lens is plano-concave or convex-concave.

In Example 4, the biometric identification system of any one of Examples 1-3 can optionally be configured such that the image-flattener lens is aspheric.

In Example 5, the biometric identification system of any one of Examples 1˜4 can optionally be configured such that the imaging lens comprises: a field lens integral with the transparent body and configured to at least partially focus the return beam to form a converging beam; and an objective lens configured to focus the converging beam to form the real image of the beam pattern at the image location.

In Example 6, the biometric identification system of any one of Examples 1-5 can optionally be configured such that the imaging lens comprises: a field lens spaced apart from the transparent body and configured to at least partially focus the return beam to form a converging beam; and an objective lens configured to focus the converging beam to form the real image of the beam pattern at the image location.

In Example 7, the biometric identification system of any one of Examples 1-6 can optionally be configured such that the sensor is curved and convex.

In Example 8, the biometric identification system of any one of Examples 1-7 can optionally be configured such that there is an absence of intervening optical elements disposed between the sensor and the imaging lens.

In Example 9, the biometric identification system of any one of Examples 1-8 can optionally be configured such that the curved platen surface is shaped to accommodate a planar membrane, the planar membrane being bendable onto the curved platen surface without causing a gap to form between the planar membrane and the curved platen surface.

In Example 10, the biometric identification system of any one of Examples 1-9 can optionally be configured such that the curved platen surface is rotationally symmetric about a central axis of the curved platen surface.

In Example 11, the biometric identification system of any one of Examples 1-10 can optionally be configured such that the curved platen surface is rotationally asymmetric about a central axis of the curved platen surface.

In Example 12, the biometric identification system of any one of Examples 1-11 can optionally be configured such that the curved platen surface is toroidal.

In Example 13, the biometric identification system of any one of Examples 1-12 can optionally further comprise at least one processor configured to: cause the sensor to capture at least one image of the beam pattern; and identify the user based at least in part on the at least one image of the beam pattern.

In Example 14, the biometric identification system of any one of Examples 1-13 can optionally further comprise: a second transparent body having a second curved platen surface, the second curved platen surface configured to be removably contacted by a second anatomy of the user, the second anatomy having a second anatomical pattern; a second illumination source configured to illuminate the second curved platen surface with a second illumination beam, the second illumination beam configured to propagate away from the second curved platen surface as a second return beam having a second beam pattern shaped to correspond to the second anatomical pattern; a second imaging lens configured to focus the second return beam to form a second real image of the second beam pattern at a second image location; and second field-curvature-correcting sensor optics including a second sensor, the second sensor being configured to sense the second real image of the second beam pattern at the second image location, wherein the anatomy and the second anatomy of the user include at least portions of a left hand and at least portions of a right hand of the user.

In Example 15, the biometric identification system of any one of Examples 1-14 can optionally further comprise: a second transparent body having a second curved platen surface, the second curved platen surface configured to be removably contacted by a second anatomy of the user, the second anatomy having a second anatomical pattern; a second illumination source configured to illuminate the second curved platen surface with a second illumination beam, the second illumination beam configured to propagate away from the second curved platen surface as a second return beam having a second beam pattern shaped to correspond to the second anatomical pattern; a second imaging lens configured to focus the second return beam to form a second real image of the second beam pattern; and a movable mirror configured to switch between a first position, at which the real image is disposed on the sensor, and a second position, at which the second real image is disposed on the sensor, wherein the anatomy and the second anatomy of the user include at least portions of a left hand and at least portions of a right hand of the user.

In Example 16, a method for operating a biometric identification system can comprise: receiving, with a curved platen surface of a transparent body, removable contact from an anatomy of a user, the anatomy having an anatomical pattern; illuminating the curved platen surface with an illumination beam; propagating the illumination beam away from the curved platen surface as a return beam having a beam pattern shaped to correspond to the anatomical pattern; focusing, with an imaging lens, the return beam to form a real image of the beam pattern at an image location; and sensing, with a sensor of field-curvature-correcting sensor optics, the real image of the beam pattern at the image location.

In Example 17, the method of Example 16 can optionally further comprise: causing, with at least one processor, the sensor to capture at least one image of the beam pattern; and identifying, with the at least one processor, the user based at least in part on the at least one image of the beam pattern.

In Example 18, a biometric identification system can comprise: a transparent body having a curved platen surface, the curved platen surface configured to be removably contacted by an anatomy of a user, the anatomy having an anatomical pattern; an illumination source configured to illuminate the curved platen surface with an illumination beam, the illumination beam configured to propagate away from the curved platen surface as a return beam having a beam pattern shaped to correspond to the anatomical pattern; a field lens configured to at least partially focus the return beam to form a converging beam; an objective lens configured to focus the converging beam to form a real image of the beam pattern at an image location; field-curvature-correcting sensor optics including a sensor, the sensor being configured to sense the real image of the beam pattern at the image location; and at least one processor configured to: cause the sensor to capture at least one image of the beam pattern; and identify the user based at least in part on the at least one image of the beam pattern.

In Example 19, the biometric identification system of Example 18 can optionally be configured such that: the sensor is planar; and the field-curvature-correcting sensor optics further include an image-flattener lens disposed between the objective lens and the sensor.

In Example 20, the biometric identification system of any one of Examples 18-19 can optionally be configured such that the sensor is curved and convex, and there is an absence of intervening optical elements disposed between the sensor and the objective lens.

The above-described examples are merely illustrative of some of the many specific examples that represent the principles described herein. Clearly, those skilled in the art may readily devise numerous other arrangements without departing from the scope as defined by the following claims.

What is claimed is:

1. A biometric identification system, comprising:
a transparent body having a curved platen surface, the curved platen surface configured to be removably contacted by an anatomy of a user, the anatomy having an anatomical pattern;
an illumination source configured to illuminate the curved platen surface with an illumination beam, the illumination beam configured to propagate away from the curved platen surface as a return beam having a beam pattern shaped to correspond to the anatomical pattern;
an imaging lens configured to focus the return beam to form a real image of the beam pattern at an image location; and
field-curvature-correcting sensor optics including a sensor, the sensor being configured to sense the real image of the beam pattern at the image location.

2. The biometric identification system of claim 1, wherein:
the sensor is planar; and
the field-curvature-correcting sensor optics further include an image-flattener lens disposed between the imaging lens and the sensor.

3. The biometric identification system of claim 2, wherein the image-flattener lens is plano-concave or convex-concave.

4. The biometric identification system of claim 2, wherein the image-flattener lens is aspheric.

5. The biometric identification system of claim 1, wherein the imaging lens comprises:
a field lens integral with the transparent body and configured to at least partially focus the return beam to form a converging beam; and
an objective lens configured to focus the converging beam to form the real image of the beam pattern at the image location.

6. The biometric identification system of claim 1, wherein the imaging lens comprises:
a field lens spaced apart from the transparent body and configured to at least partially focus the return beam to form a converging beam; and
an objective lens configured to focus the converging beam to form the real image of the beam pattern at the image location.

7. The biometric identification system of claim 1, wherein the sensor is curved and convex.

8. The biometric identification system of claim 7, wherein there is an absence of intervening optical elements disposed between the sensor and the imaging lens.

9. The biometric identification system of claim 1, wherein the curved platen surface is shaped to accommodate a planar membrane, the planar membrane being bendable onto the curved platen surface without causing a gap to form between the planar membrane and the curved platen surface.

10. The biometric identification system of claim 1, wherein the curved platen surface rotationally symmetric about a central axis of the curved platen surface.

11. The biometric identification system of claim 1, wherein the curved platen surface is rotationally asymmetric about a central axis of the curved platen surface.

12. The biometric identification system of claim 1, wherein the curved platen surface is toroidal.

13. The biometric identification system of claim 1, further comprising at least one processor configured to:
cause the sensor to capture at least one image of the beam pattern; and
identify the user based at least in part on the at least one image of the beam pattern.

14. The biometric identification system of claim 1, further comprising:
a second transparent body having a second curved platen surface, the second curved platen surface configured to be removably contacted by a second anatomy of the user, the second anatomy having a second anatomical pattern;
a second illumination source configured to illuminate the second curved platen surface with a second illumination beam, the second illumination beam configured to propagate away from the second curved platen surface as a second return beam having a second beam pattern shaped to correspond to the second anatomical pattern;
a second imaging lens configured to focus the second return beam to form a second real image of the second beam pattern at a second image location; and
second field-curvature-correcting sensor optics including a second sensor, the second sensor being configured to sense the second real image of the second beam pattern at the second image location,
wherein the anatomy and the second anatomy of the user include at least portions of a left hand and at least portions of a right hand of the user.

15. The biometric identification system of claim 1, further comprising:
a second transparent body having a second curved platen surface, the second curved platen surface configured to be removably contacted by a second anatomy of the user, the second anatomy having a second anatomical pattern;
a second illumination source configured to illuminate the second curved platen surface with a second illumination beam, the second illumination beam configured to propagate away from the second curved platen surface as a second return beam having a second beam pattern shaped to correspond to the second anatomical pattern;
a second imaging lens configured to focus the second return beam to form a second real image of the second beam pattern; and
a movable mirror configured to switch between a first position, at which the real image is disposed on the sensor, and a second position, at which the second real image is disposed on the sensor,
wherein the anatomy and the second anatomy of the user include at least portions of a left hand and at least portions of a right hand of the user.

16. A method for operating a biometric identification system, the method comprising:
receiving, with a curved platen surface of a transparent body, removable contact from an anatomy of a user, the anatomy having an anatomical pattern;
illuminating the curved platen surface with an illumination beam;
propagating the illumination beam away from the curved platen surface as a return beam having a beam pattern shaped to correspond to the anatomical pattern;
focusing, with an imaging lens, the return beam to form a real image of the beam pattern at an image location; and
sensing, with a sensor of field-curvature-correcting sensor optics, the real image of the beam pattern at the image location.

17. The method of claim 16, further comprising:
causing, with at least one processor, the sensor to capture at least one image of the beam pattern; and
identifying, with the at least one processor, the user based at least in part on the at least one image of the beam pattern.

18. A biometric identification system, comprising:
a transparent body having a curved platen surface, the curved platen surface configured to be removably contacted by an anatomy of a user, the anatomy having an anatomical pattern;
an illumination source configured to illuminate the curved platen surface with an illumination beam, the illumination beam configured to propagate away from the curved platen surface as a return beam having a beam pattern shaped to correspond to the anatomical pattern;
a field lens configured to at least partially focus the return beam to form a converging beam;
an objective lens configured to focus the converging beam to form a real image of the beam pattern at an image location;
field-curvature-correcting sensor optics including a sensor, the sensor being configured to sense the real image of the beam pattern at the image location; and
at least one processor configured to:
cause the sensor to capture at least one image of the beam pattern; and
identify the user based at least in part on the at least one image of the beam pattern.

19. The biometric identification system of claim 18, wherein:
the sensor is planar; and
the field-curvature-correcting sensor optics further include an image-flattener lens disposed between the objective lens and the sensor.

20. The biometric identification system of claim 18, wherein the sensor is curved and convex, and there is an absence of intervening optical elements disposed between the sensor and the objective lens.
